(19) United States
(12) Patent Application Publication
(10) Pub. No.: US 2024/0284313 A1
(43) Pub. Date: Aug. 22, 2024

(54) COMMUNICATION APPARATUS, SYSTEM AND CONTROL METHOD FOR THE SAME, AND STORAGE MEDIUM

(71) Applicant: CANON KABUSHIKI KAISHA, Tokyo (JP)

(72) Inventor: AYUMI SUZUKI, Kanagawa (JP)

(21) Appl. No.: 18/440,644

(22) Filed: Feb. 13, 2024

(30) Foreign Application Priority Data
Feb. 16, 2023 (JP) 2023-022636

(51) Int. Cl. H04W 48/16; H04W 8/00

(52) U.S. Cl. CPC H04W 48/16; H04W 8/005

(57) ABSTRACT

A communication apparatus comprises: a search unit that searches for one or more connectable networks; an exclusion unit that excludes information regarding a network through which communication is performed using a predetermined encryption scheme from information regarding the connectable networks; a transmitter that transmits to an external apparatus the information regarding the connectable networks except for the information regarding the network excluded by the exclusion unit; a receiver that receives information regarding a network selected by the external apparatus based on the transmitted information regarding networks, and a communication parameter for connecting to the selected network; and a connection unit that connects to the selected network based on the information regarding the selected network received by the receiver and information regarding the communication parameter.

### BACKGROUND OF THE INVENTION

### Field of the Invention

The present invention relates to a communication apparatus, a system and a control method for the same, and a storage medium, and particularly relates to selection of a network and setting of communication parameters.

### Description of the Related Art

In recent years, there have been an increasing number of cases in which communication apparatuses equipped with a wireless communication function, such as digital cameras and printers, are connected to a wireless network and used. In order to connect a communication apparatus to a wireless network, it is necessary to set various communication parameters such as an encryption scheme, an encryption key, an authentication scheme, and an authentication key.

If the communication apparatus has a user interface with high operability like a personal computer, it is easy to set communication parameters. However, with a communication apparatus having a user interface (e.g. a screen and operation members) with poor operability compared to a personal computer, setting communication parameters is a very troublesome and time-consuming task.

For example, Japanese Patent Laid-Open No. 2017-188869 discloses a technique by which a communication apparatus having a user interface with high operability acquires a list of wireless networks accessible from an external apparatus having poor screen and operation members, and connects the external apparatus to the same wireless network as the communication apparatus.

Japanese Patent Laid-Open No. 2020-021982 discloses a technique by which, when a terminal apparatus is used to connect an external electronic device to a wireless network, the terminal apparatus acquires a list of wireless networks accessible from the electronic device, and displays wireless networks stored in the terminal apparatus in such a mode that the user can easily select.

However, with the techniques disclosed in Japanese Patent Laid-Open No. 2017-188869 and Japanese Patent Laid-Open No. 2020-021982, the list acquired as a list of wireless networks accessible from an external apparatus may include a network with a security vulnerability. As security technology continues to evolve, connections to vulnerable networks that use older encryption techniques should be avoided. Meanwhile, some communication apparatuses detect such vulnerable networks and display a warning when the user attempts to connect to such a network, or prohibit the connection.

### SUMMARY OF THE INVENTION

The present invention has been made in consideration of the above situation, and when a user sets, from a communication apparatus, a wireless network to which an external apparatus connects, the present invention prevents the user from setting a vulnerable network without the user being aware of the prevention.

According to the present invention, provided is a communication apparatus comprising one or more processors and/or circuitry which function as: a search unit that searches for one or more connectable networks; an exclusion unit that excludes information regarding a network through which communication is performed using a predetermined encryption scheme from information regarding the connectable networks; a transmitter that transmits to an external apparatus the information regarding the connectable networks except for the information regarding the network excluded by the exclusion unit; a receiver that receives information regarding a network selected by the external apparatus based on the transmitted information regarding networks, and a communication parameter for connecting to the selected network; and a connection unit that connects to the selected network based on the information regarding the selected network received by the receiver and information regarding the communication parameter.

Further, according to the present invention, provided is a communication apparatus comprising one or more processors and/or circuitry which function as: an acquisition unit that acquires information regarding one or more connectable networks for the external apparatus; an exclusion unit that excludes information regarding a network through which communication is performed using a predetermined encryption scheme from information regarding the connectable networks for the external apparatus; a display unit that displays a list of information regarding the connectable networks for the external apparatus, except for the information regarding the network excluded by the exclusion unit; an operation unit that prompts a user to select a network from the displayed list of information regarding networks, and to prompt the user to enter a communication parameter used to connect to the selected network; and a transmitter that transmits information regarding the selected network and the communication parameter to the external apparatus.

Furthermore, according to the present invention, provided is a system including a first communication apparatus and a second communication apparatus that communicates with the first communication apparatus, the system comprising an exclusion unit that excludes information regarding a network through which communication is performed using a predetermined encryption scheme in at least one of the first communication apparatus and the second communication apparatus, from information regarding one or more connectable networks for the first communication apparatus, the second communication apparatus comprising one or more processors and/or circuitry which function as: a display unit that displays a list of information regarding the connectable networks for the first apparatus, except for the information regarding the network excluded by the exclusion unit; an operation unit that prompts a user to select a network from the displayed list of information regarding networks, and to prompt the user to enter a communication parameter used to connect to the selected network; and a transmitter that transmits to the first communication apparatus the information regarding the selected network and the communication parameter.

Further, according to the present invention, provided is a method for controlling a system including a first communication apparatus and a second communication apparatus that communicates with the first communication apparatus, the method comprising: excluding information regarding a network through which communication is performed using a predetermined encryption scheme in at least one of the first communication apparatus and the second communication apparatus, from information regarding one or more connectable networks for the first communication apparatus, displaying, on a display unit of the second communication apparatus, a list of information regarding the connectable networks for the first apparatus, except for the information regarding the excluded network; the second communication apparatus, prompting a user to select a network from the list of information regarding networks displayed on the display unit; in the second communication apparatus, prompting the user to enter a communication parameter used to connect to the selected network; and transmitting the information regarding the selected network and the communication parameter from the second communication apparatus to the first communication apparatus.

Further, according to the present invention, provided is a non-transitory computer-readable storage medium, the storage medium storing a program that is executable by the computer, wherein the program includes program code for causing the computer to function as a communication apparatus comprising: a search unit that searches for one or more connectable networks; an exclusion unit that excludes information regarding a network through which communication is performed using a predetermined encryption scheme from information regarding the connectable networks; a transmitter that transmits to an external apparatus the information regarding the connectable networks except for the information regarding the network excluded by the exclusion unit; a receiver that receives information regarding a network selected by the external apparatus based on the transmitted information regarding networks, and a communication parameter for connecting to the selected network; and a connection unit that connects to the selected network based on the information regarding the selected network received by the receiver and information regarding the communication parameter.

Further, according to the present invention, provided is a non-transitory computer-readable storage medium, the storage medium storing a program that is executable by the computer, wherein the program includes program code for causing the computer to function as a communication apparatus comprising: an acquisition unit that acquires information regarding one or more connectable networks for the external apparatus; an exclusion unit that excludes information regarding a network through which communication is performed using a predetermined encryption scheme from information regarding the connectable networks for the external apparatus; a display unit that displays a list of information regarding the connectable networks for the external apparatus, except for the information regarding the network excluded by the exclusion unit; an operation unit that prompts a user to select a network from the displayed list of information regarding networks, and to prompt the user to enter a communication parameter used to connect to the selected network; and a transmitter that transmits information regarding the selected network and the communication parameter to the external apparatus.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing an example of a functional configuration of a smartphone according to embodiments of the present invention.

FIG. 2A is a block diagram showing an example of a functional configuration of a digital camera according to the embodiments.

FIG. 2B is a front view of the digital camera.

FIG. 2C is a rear view of the digital camera.

FIG. 3 is a sequence diagram showing communication parameter setting processing performed between the smartphone and the digital camera according to a first embodiment.

FIGS. 4A to 4F are diagrams showing examples of screens displayed on the smartphone according to the first embodiment.

FIG. 5A is a list of pieces of information regarding networks detected by the digital camera according to the first embodiment.

FIG. 5B is a diagram showing an example of a list excluding pieces of information regarding some of the networks.

FIG. 6 is a sequence diagram showing communication parameter setting processing performed between the smartphone and the digital camera according to a second embodiment.

FIG. 7 is a diagram showing an example of network information displayed on the smartphone according to the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

A first embodiment describes processing performed by a smartphone 100 and a digital camera 200 to communicate with each other, in which a user operates a user interface of the smartphone 100 to set communication parameters to the digital camera 200.

### Configuration of Smartphone 100

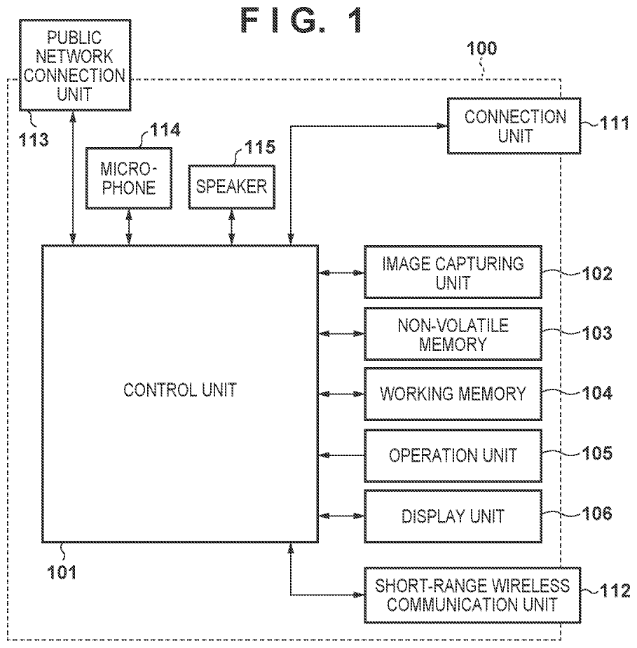

First, the configuration and functions of the smartphone 100 according to the present embodiment will be described with reference to FIG. 1.

FIG. 1 is a block diagram showing an example of a functional configuration of the smartphone 100, which is an example of a communication apparatus according to the present embodiment. Although a smartphone is described here as an example of a communication apparatus, the communication apparatus is not limited to being a smartphone. For example, a communication apparatus may be a tablet device with wireless communication capabilities, a personal computer, or the like.

A control unit 101 controls each of the units included in the smartphone 100 according to input signals and the programs described below. Instead of the control unit 101 controlling the entire smartphone 100, a plurality of pieces of hardware may share processing to control the entire smartphone 100.

An image capturing unit 102 converts the optical image of the subject formed by the lens included in the image capturing unit 102 into an electrical signal, and outputs, as image data, digital data obtained by performing noise reduction processing, analog-to-digital conversion processing, and so on on the electrical signal. Note that the image data thus obtained is stored in a buffer memory, and is thereafter used by the control unit 101 to perform a predetermined computation.

A non-volatile memory 103 is an electrically erasable and recordable non-volatile memory. The non-volatile memory 103 stores an operating system (OS), which is basic software executed by the control unit 101, and applications that cooperate with the OS to realize applied functions. Note that in the present embodiment, an application that is used to communicate with the digital camera 200 is stored in the non-volatile memory 103.

A working memory 104 is used as an image display memory for a display unit 106, a working area for the control unit 101, and so on.

An operation unit 105 is used to accept an instruction for the smartphone 100 from a user. The operation unit 105 includes, for example, operation members such as a power button used by the user to input an instruction to turn on or off the smartphone 100, a touch panel formed on the display unit 106, and so on.

The display unit 106 displays image data, and displays characters, icons, or the like for interactive operations, for example. The display unit 106 need not be included in the smartphone 100, and the smartphone 100 need only have to be provided with a display control function, which is the function of connecting to the display unit 106 and controlling the display on the display unit 106.

A connection unit 111 is a communication interface that is used to connect to an external apparatus, including one or more communication circuits or communication modules. It is assumed that the connection unit 111 according to the present embodiment performs wireless communication in accordance with, for example, the IEEE 802.11x (x is b, a, g, n, ac, etc.) standard under the control of the control unit 101. In the present embodiment, the connection unit 111 is used to communicate with a public network or an external apparatus (the digital camera 200) via a wireless LAN access point (AP), which is an external apparatus. Here, the public network is a public computer network that cannot be directly accessed by the connection unit 111, such as the Internet.

A short-range wireless communication unit 112 includes, for example, an antenna for wireless communication, a modulation and demodulation circuit for processing wireless signals, and a communication controller. The short-range wireless communication unit 112 outputs a modulated wireless signal from an antenna, or demodulates a wireless signal received by the antenna, thereby realizing short-range wireless communication in accordance with the IEEE 802.15 standard (so-called Bluetooth (registered trademark)). The short-range wireless communication unit 112 is capable of controlling the establishment and termination of communication, treating communication using the Bluetooth (registered trademark) Low Energy communication scheme and communication using the Bluetooth (registered trademark) Classic communication scheme as different types of communication. Both Bluetooth (registered trademark) Low Energy communication and Bluetooth (registered trademark) Classic communication use the 2.4 GHz frequency band.

The smartphone 100 according to the present embodiment is capable of exchanging data with the digital camera 200 via the short-range wireless communication unit 112. Note that communication with the digital camera 200 is not limited to such communication. For example, the short-range wireless communication unit 112 may include a wireless communication module such as an infrared module, a Wireless USB, or the like. Furthermore, a wired connection such as a USB cable, HDMI (registered trademark), or IEEE 1394 may be used.

A public network connection unit 113 is an interface that is used to perform public wireless communication. The smartphone 100 is capable of making and receiving calls to and from other apparatuses via the public network connection unit 113. At this time, the control unit 101 inputs and outputs audio signals via a microphone 114 and a speaker 115 to realize calls. In the present embodiment, the public network connection unit 113 is an antenna, and the control unit 101 is capable of connecting to a public network via the antenna. Note that a single antenna can be used as both the connection unit 111 and the public network connection unit 113.

### Configuration of Digital Camera 200

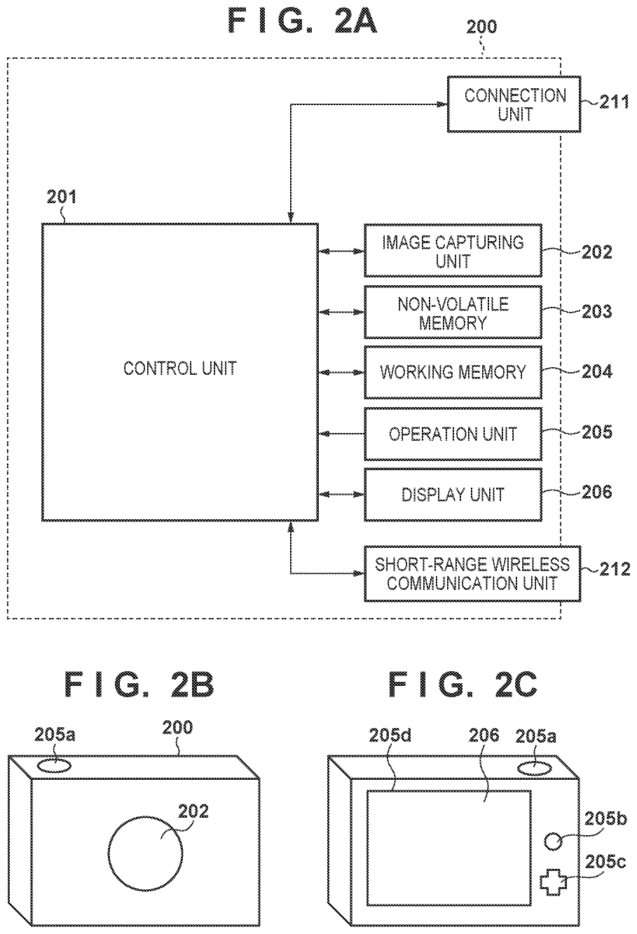

Next, the configuration and functions of the digital camera 200 according to the present embodiment will be described with reference to FIGS. 2A to 2C.

FIG. 2A is a block diagram showing an example of a functional configuration of the digital camera 200, which is an example of an external apparatus according to the present embodiment. Although a digital camera is described here as an example of an external apparatus, the external apparatus is not limited to being a digital camera. For example, the external apparatus may be an apparatus such as a printer or a smart watch.

A control unit 201 includes hardware (for example, a processor) for executing programs stored in a non-volatile memory 203. The control unit 201 controls each of the units included in the digital camera 200 by executing the programs recorded in the non-volatile memory 203. Instead of the control unit 201 controlling the entire digital camera 200, a plurality of pieces of hardware may share processing to control the entire digital camera 200.

An image capturing unit 202 includes, for example, a lens unit, an image sensor for converting the optical image of the subject formed on an imaging surface via the lens unit into an electrical signal, and an image processing unit that generates a still image or a moving image from the electrical signal generated by the image sensor. For example, a complementary metal oxide semiconductor (CMOS) sensor or a charge coupled device (CCD) is used as the image sensor.

The non-volatile memory 203 is a non-volatile memory in which, for example, programs executed by the control unit 201 are recorded. In addition, the control unit 201 is capable of recording moving image data and still image data in the non-volatile memory 203.

A working memory 204 is used as a buffer memory that temporarily holds still image data and moving image data captured by the image capturing unit 202, an image display memory for a display unit 206, a working area for the control unit 201, and so on.

An operation unit 205 is a user interface (UI) that is used to accept instructions for the digital camera 200 from a user. The operation unit 205 includes, for example, a power switch used by the user to input an instruction to turn on or off the digital camera 200, a release switch that is used to input an instruction to capture an image, a playback button that is used to input an instruction to reproduce still image data, and so on. The touch panel formed on the display unit 206 may also be included in the operation unit 205. The release switch has SW1 and SW2, and when the release switch is in a so-called half-pressed state, SW1 is turned on, and the release switch accepts an image capturing preparation instruction. As a result, preparation operations for image capturing, such as autofocus (AF) processing, auto exposure (AE) processing, auto white balance (AWB) processing, and pre-flash emission (EF) processing, are performed. When the release switch is in a so-called fully pressed state, SW2 is turned on, and the release switch accepts an image capturing instruction. As a result, image capturing operations are performed.

The display unit 206 displays a through image during preparation for image capturing (a so-called live view image), displays captured still image data and moving image data, and displays characters, icons, and so on for interactive operations, for example. The display unit 206 is a liquid crystal display or an LED display, for example. Note that the display unit 206 need not be included in the digital camera 200, and may be configured to be connected externally to the digital camera 200. That is to say, the digital camera 200 need only be able to connect to an internal or external display unit 206, and have at least a display control function, which is the function of controlling the display on the display unit 206. An example of an external display unit 206 is a view finder that can be connected to the digital camera 200.

A connection unit 211 is a communication interface that is used to connect to an external apparatus, including one or more communication circuits or communication modules. It is assumed that the connection unit 211 according to the present embodiment performs wireless communication in accordance with, for example, the IEEE 802.11x (x is b, a, g, n, ac, etc.) standard under the control of the control unit 201. In the present embodiment, the connection unit 211 is used to communicate with a public network or an external apparatus (the smartphone 100) via an AP, which is an external apparatus. Here, the public network is a public computer network that cannot be directly accessed by the connection unit 211, such as the Internet.

A short-range wireless communication unit 212 includes, for example, an antenna for wireless communication, a modulation and demodulation circuit for processing wireless signals, and a communication controller. The short-range wireless communication unit 212 outputs a modulated wireless signal from an antenna, or demodulates a wireless signal received by the antenna, thereby realizing short-range wireless communication in accordance with the IEEE 802.15 standard (so-called Bluetooth (registered trademark)). The short-range wireless communication unit 212 is capable of controlling the establishment and termination of communication, treating communication using the Bluetooth (registered trademark) Low Energy communication scheme and communication using the Bluetooth (registered trademark) Classic communication scheme as different types of communication. Both Bluetooth (registered trademark) Low Energy communication and Bluetooth (registered trademark) Classic communication use the 2.4 GHz frequency band.

The digital camera 200 according to the present embodiment is capable of exchanging data with the smartphone 100 via the short-range wireless communication unit 212. Note that communication with the digital camera 100 is not limited to such communication. For example, the short-range wireless communication unit 212 may include a wireless communication module such as an infrared module, a Wireless USB, or the like. Furthermore, a wired connection such as a USB cable, HDMI (registered trademark), or IEEE 1394 may be used.

Next, an example of an external appearance of the digital camera 200 will be described. FIG. 2B is a front view showing an example of a front side of the digital camera 200, and FIG. 2C is a rear view showing an example of a rear side of the digital camera 200. A release switch 205a, a playback button 205b, a direction key 205c, and a touch panel 205d are operation members included in the operation unit 205, and are used to input various operation instructions to the control unit 201. The touch panel 205d is capable of receiving an input instruction by detecting a position touched by the user and associating the instruction with the character, icon, or the like displayed at the detected position on the display unit 206.

### Communication Parameter Setting Processing Performed by Smartphone 100 and Digital Camera 200

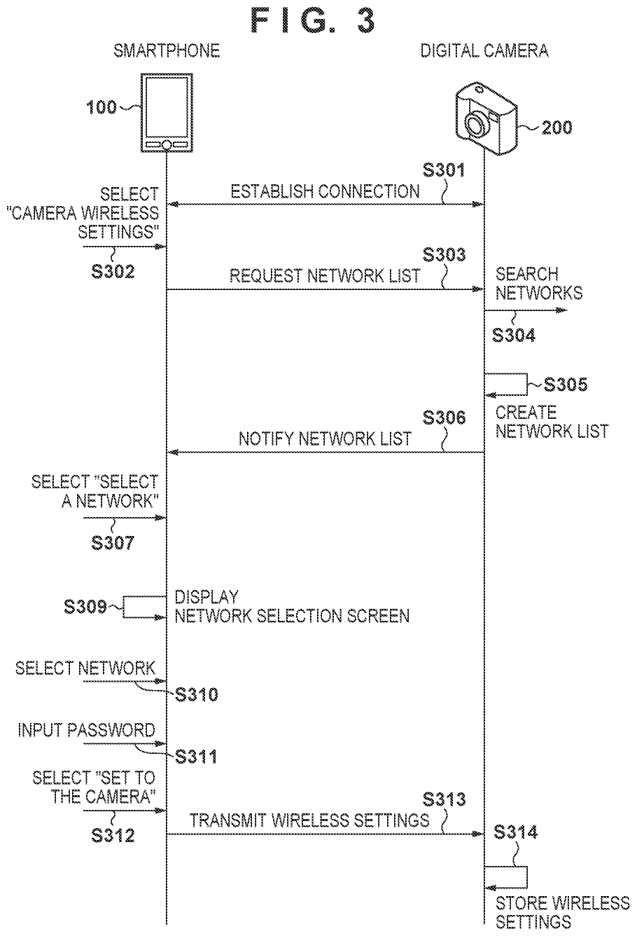

Next, communication parameter setting processing performed by the smartphone 100 and the digital camera 200 according to the present embodiment will be described with reference to FIGS. 3 to 5B.

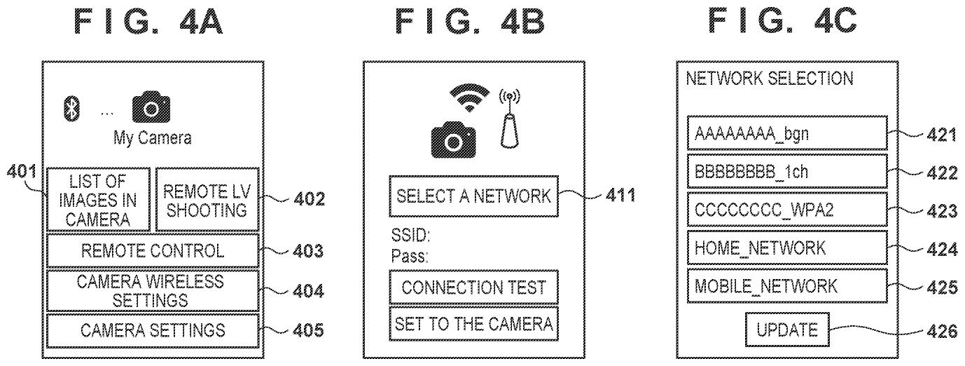

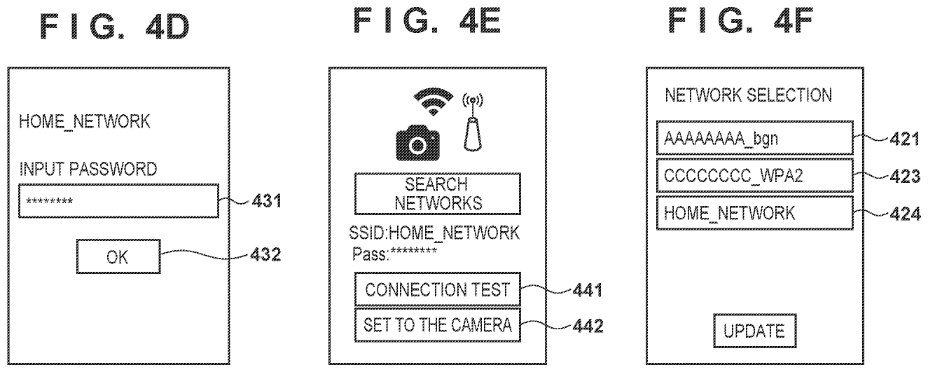

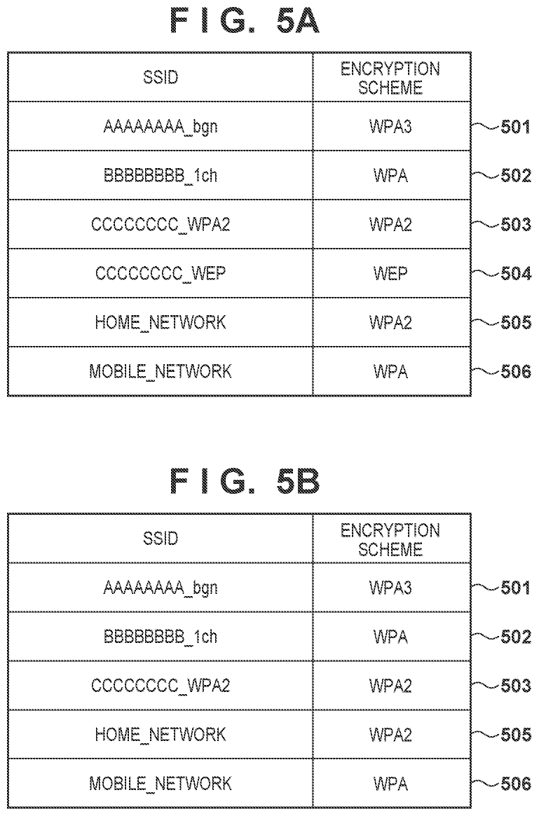

FIG. 3 shows a sequence through which the smartphone 100 according to the present embodiment communicates with the digital camera 200 to perform communication parameter setting processing. FIGS. 4A to 4F show examples of UI screens displayed on the smartphone 100 according to the present embodiment. FIG. 5A shows information regarding networks detected by the digital camera 200 according to the present embodiment, and FIG. 5B shows an example in which networks using encryption schemes that are determined by the digital camera 200 to be vulnerable are excluded from the list.

First, in step S301, a connection between the smartphone 100 and the digital camera 200 is established. The control unit 101 of the smartphone 100 establishes a connection with the digital camera 200 via the connection unit 111 and the connection unit 211, or the short-range wireless communication unit 112 and the short-range wireless communication unit 212. The communication scheme used here to establish the connection may be, for example, a wireless LAN connection according to the IEEE 802.11 standard, or a Bluetooth (registered trademark) connection according to the IEEE 802.15 standard. Note that the communication scheme is not limited to being wireless. For example, a wired connection such as IEEE 1394 may be used. The subsequent processing may be realized by switching between a plurality of communication schemes or using a plurality of communication schemes simultaneously.

Upon a connection between the smartphone 100 and the digital camera 200 being established, the control unit 101 of the smartphone 100 displays a screen showing a list of network functions on the display unit 106 as shown in FIG. 4A. Example items of network functions selectable on the screen showing the list of network functions include a “list of the images in the camera” button 401 that is used to display a list of the images stored in the digital camera 200, a “remote live view (LV) shooting” button 402 that is used to remotely control the digital camera 200, a “remote control” button 403, a “camera wireless settings” button 404 that is used to set the wireless settings of the digital camera 200, and a “camera settings” button 405 that is used to check or change the settings of the digital camera 200. The user can select any of the items including the “camera wireless settings” from the items of the network functions shown in FIG. 4A, using the operation unit 105.

In step S302, if the user selects the “camera wireless settings” button 404 from among the items of the network functions displayed on the display unit 106 of the smartphone 100, the control unit 101 of the smartphone 100 requests a network list from the digital camera 200 in step S303. Note that the processing in step S303 may be performed upon step S301 being complete, or after the user selects “select a network” in step S307, which will be described later.

In step S304, the control unit 201 of the digital camera 200 performs network search processing to acquire AP information from beacons emitted by APs present around the digital camera 200, via the connection unit 211. In step S305, network list creation processing is performed using the acquired AP information.

FIG. 5A shows an example of the AP information acquired in step S304. Examples of AP information that can be acquired by the digital camera 200 performing network search processing include a service set identifier (SSID), a frequency, a channel, an encryption scheme, and so on. Here, six pieces of AP information 501 to 506 that have been acquired are listed with respect to the SSID and the encryption scheme.

Next, in step S305, the digital camera 200 performs processing to exclude from the list a network that uses an encryption scheme that is determined to be vulnerable. Examples of methods of determining vulnerability include a method of determining a fixed encryption scheme such as WEP to be vulnerable, or querying an external apparatus to which the digital camera 200 is separately connected, to acquire an encryption scheme that should be excluded based on current security. FIG. 5B shows an example of a list excluding a network determined to be vulnerable. Here, the AP information 504 indicating that the encryption scheme is WEP is excluded.

In step S306, in response to the network list requesting processing in step S303, the control unit 201 of the digital camera 200 notifies the smartphone 100 of the network list created in step S305.

Meanwhile, the smartphone 100 transitions to displaying the camera wireless setting screen shown in FIG. 4B. On this screen, if the user selects the “select a network” button 411 using the operation unit 105 in step S307, the control unit 101 of the smartphone 100 displays the network selection screen on the display unit 106 in step S309 using the network list information notified in step S306.

FIG. 4C is an example of a network selection screen created by the control unit 101 of the smartphone 100 using the network list information acquired in step S306. Here, the smartphone 100 displays only the SSIDs in the network list information, which is a typical display. Note that the pieces of AP information 421 to 425 shown in FIG. 4C correspond to the pieces of AP information 501, 502, 503, 505, and 506 in FIG. 5B.

The “update” button 426 in FIG. 4C is selected when a desired AP is not found to enable the control unit 101 of the smartphone 100 and the control unit 201 of the digital camera 200 to perform steps S303 to S306 again and to update the display of the network selection screen in step S309.

In step S310, the user selects the network to be set to the digital camera 200 from the network selection screen shown in FIG. 4C, using the operation unit 105. Upon the user selecting a network, the control unit 101 of the smartphone 100 executes password input processing in step S311.

In step S311, the control unit 101 of the smartphone 100 displays a password input screen shown in FIG. 4D on the display unit 106. The user can enter a password in a password input field 431 for the network selected in step S310 on the password input screen shown in FIG. 4D, using the operation unit 105, and confirm the password by pressing an “OK” button 432.

In step S312, the control unit 101 of the smartphone 100 displays a setting screen for setting to the camera, as shown in FIG. 4E, on the display unit 106. As a result, the user can select any of the items including the item “set to the camera” on the setting screen for setting to the camera shown in FIG. 4E, using the operation unit 105. If the user selects the “set to the camera” button 442 on the setting screen for setting to the camera, the control unit 101 of the smartphone 100 performs communication parameter transmission processing in step S313. Note that if the user selects a “connection test” button 441 that is selectable on the setting screen for setting to the camera shown in FIG. 4E, a test may be performed regarding whether or not the network is accessible using the network password entered in step S311.

In step S313, the control unit 101 of the smartphone 100 transmits communication parameters to the digital camera 200. Examples of communication parameters transmitted at this time include communication parameters required for the wireless connection, such as the SSID and password.

In step S314, the control unit 201 of the digital camera 200 stores the communication parameters received from the smartphone 100 in the non-volatile memory 203. The control unit 201 of the digital camera 200 can now connect to the AP via the connection unit 211, using the communication parameters stored in the non-volatile memory 203.

As described above, according to the first embodiment, when a user sets, from a smartphone, a wireless network to which a digital camera connects, it is possible to prevent the user from setting a vulnerable network without the user being aware of the prevention.

### Second Embodiment

Next, a second embodiment of the present invention will be described.

In the first embodiment, networks that use encryption schemes determined to be vulnerable by the digital camera 200 are excluded from the networks detected by the digital camera 200 so that networks with high security risks are not set. In this case, the encryption schemes determined by the digital camera 200 to be vulnerable are encryption schemes fixed at the time of development of the digital camera, or encryption schemes determined by querying a separately connected external apparatus.

However, as security technology evolves, fixed encryption schemes will no longer be a sufficient security measure, and the OS of the smartphone 100 may display a security warning, or a connection error may occur at the connection when the user selects the “connection test” button 441 shown in FIG. 4E. In addition, it is extremely inconvenient for users to, in order to inquire about the latest security information, connect to an external apparatus that is different from the network for which the user originally wished to make connection settings, and some users may be forced to perform difficult procedures.

Therefore, in the second embodiment, a method for easily setting an appropriate network in accordance with evolving security technology will be described. Note that the configurations of the smartphone 100 and the digital camera 200 used in the second embodiment are the same as those described in the first embodiment, and therefore the descriptions thereof will be omitted.

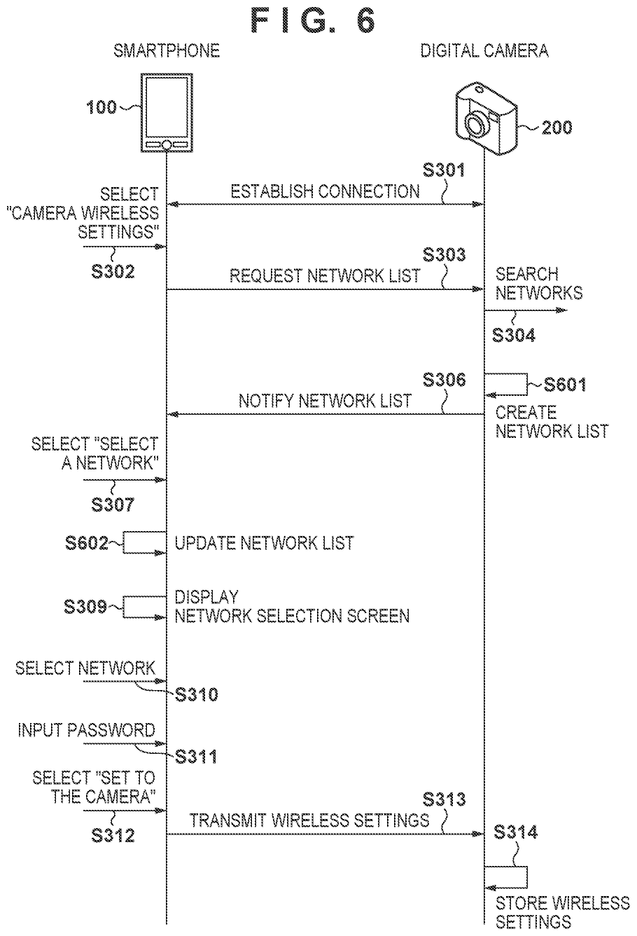

FIG. 6 shows a sequence through which the smartphone 100 according to the present embodiment communicates with the digital camera 200 to perform communication parameter setting processing. This sequence is different from the sequence described in the first embodiment with reference to FIG. 3 in that step S601 is performed instead of the processing in step S305, and the processing in step S602 is added. Steps other than these steps are the same as the steps in FIG. 3, so the same numbers are given thereto and the descriptions thereof are omitted.

In the above-described first embodiment, in step S305, the digital camera 200 creates a list of networks excluding networks determined to be vulnerable. In contrast, in the second embodiment, in step S601, the digital camera 200 creates a list of the networks detected in step S304 without change. In other words, the AP information shown in FIG. 5A is notified to the smartphone 100 as a network list in step S306. However, as described in relation to step S305, networks that are determined to be vulnerable may be excluded.

In step S307, if the user selects the “select a network” button 411 on the screen displayed on the display unit 106 of the smartphone 100 shown in FIG. 4B, the smartphone 100 performs processing to update the network list in step S602 in the present embodiment. Here, the control unit 101 of the smartphone 100 determines whether or not a vulnerable encryption scheme is included in the network list notified from the digital camera 200, and if such an encryption scheme is included, the control unit 101 excludes it from the network list. As a method for determining whether or not a vulnerable encryption scheme is included, it is possible to use a method of making the determination with reference to information held by the OS of the smartphone 100, or a method of acquiring information from an external apparatus connected to the smartphone 100 via the connection unit 111. As a result, even if vulnerability information regarding security technology held by the digital camera 200 becomes outdated, it is possible to appropriately determine and exclude vulnerable networks.

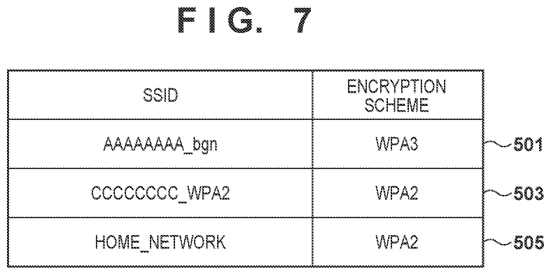

FIG. 7 is an example of a network list updated by excluding vulnerable networks therefrom. Compared to FIG. 5A, AP information 504 whose encryption method is WEP and AP information 502 and 506 whose encryption method is WPA are excluded.

Subsequently, in step S309, the control unit 101 of the smartphone 100 displays a network selection screen on the display unit 106, using the network list information updated in step S308. FIG. 4F shows an example of the network selection screen displayed in step S309. Compared to the network selection screen shown in FIG. 4C, the networks 422 and 425 whose encryption scheme is WPA have been deleted.

As a result, at the connection when the “connection test” button 441 in FIG. 4E is selected, the OS of the smartphone 100 will no longer display a security warning or set a vulnerable network that would result in a connection error, even without the user's intent.

Note that in the present embodiment, in step S602, the control unit 101 of the smartphone 100 determines whether or not a vulnerable encryption scheme is included in the network list notified from the digital camera 200, and if such an encryption scheme is included, the control unit 101 excludes it from the network list. As another method, it is possible to first notify the digital camera 200 from the smartphone 100 of information regarding vulnerable encryption schemes, so that the digital camera 200 excludes networks with vulnerable encryption schemes when creating a list of networks.

In addition, it is possible not only to exclude networks with vulnerable encryption schemes from the network list, but also to determine networks with encryption schemes that are recommended to the user, and display the networks in priority order or highlight the networks. By displaying the networks in this way, the user can easily select a safer network from among a plurality of networks.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-022636, filed Feb. 16, 2023 which is hereby incorporated by reference herein in its entirety.

What is claimed is:

1. A communication apparatus comprising one or more processors and/or circuitry which function as:
a search unit that searches for one or more connectable networks;
an exclusion unit that excludes information regarding a network through which communication is performed using a predetermined encryption scheme from information regarding the connectable networks;
a transmitter that transmits to an external apparatus the information regarding the connectable networks except for the information regarding the network excluded by the exclusion unit;
a receiver that receives information regarding a network selected by the external apparatus based on the transmitted information regarding networks, and a communication parameter for connecting to the selected network; and
a connection unit that connects to the selected network based on the information regarding the selected network received by the receiver and information regarding the communication parameter.

2. The communication apparatus according to claim 1,
wherein the exclusion unit excludes the information regarding the network based on information regarding an encryption scheme held in advance.

3. The communication apparatus according to claim 1,
wherein the exclusion unit excludes the information regarding the network based on information regarding an encryption scheme transmitted from the external apparatus.

4. A communication apparatus comprising one or more processors and/or circuitry which function as:
an acquisition unit that acquires information regarding one or more connectable networks for the external apparatus;
an exclusion unit that excludes information regarding a network through which communication is performed using a predetermined encryption scheme from information regarding the connectable networks for the external apparatus;
a display unit that displays a list of information regarding the connectable networks for the external apparatus, except for the information regarding the network excluded by the exclusion unit;
an operation unit that prompts a user to select a network from the displayed list of information regarding networks, and to prompt the user to enter a communication parameter used to connect to the selected network; and
a transmitter that transmits information regarding the selected network and the communication parameter to the external apparatus.

5. The communication apparatus according to claim 4,
wherein the exclusion unit excludes the information regarding the network based on information regarding an encryption scheme held in advance.

6. The communication apparatus according to claim 4,
wherein the exclusion unit excludes the information regarding the network based on information regarding an encryption scheme acquired from an outside.

7. The communication apparatus according to claim 4, further comprising:
a determination unit that determines a priority order of the information regarding the networks except for the information regarding the network excluded by the exclusion unit,
wherein the display unit displays the information regarding the networks based on the priority order.

8. A system including a first communication apparatus and a second communication apparatus that communicates with the first communication apparatus, the system comprising an exclusion unit that excludes information regarding a network through which communication is performed using a predetermined encryption scheme in at least one of the first communication apparatus and the second communication apparatus, from information regarding one or more connectable networks for the first communication apparatus,
the second communication apparatus comprising one or more processors and/or circuitry which function as:
a display unit that displays a list of information regarding the connectable networks for the first apparatus, except for the information regarding the network excluded by the exclusion unit;
an operation unit that prompts a user to select a network from the displayed list of information regarding networks, and to prompt the user to enter a communication parameter used to connect to the selected network; and
a transmitter that transmits to the first communication apparatus the information regarding the selected network and the communication parameter.

9. A method for controlling a system including a first communication apparatus and a second communication apparatus that communicates with the first communication apparatus, the method comprising:
excluding information regarding a network through which communication is performed using a predetermined encryption scheme in at least one of the first communication apparatus and the second communication apparatus, from information regarding one or more connectable networks for the first communication apparatus,
displaying, on a display unit of the second communication apparatus, a list of information regarding the connectable networks for the first apparatus, except for the information regarding the excluded network;
the second communication apparatus, prompting a user to select a network from the list of information regarding networks displayed on the display unit;
in the second communication apparatus, prompting the user to enter a communication parameter used to connect to the selected network; and
transmitting the information regarding the selected network and the communication parameter from the second communication apparatus to the first communication apparatus.

10. A non-transitory computer-readable storage medium, the storage medium storing a program that is executable by the computer, wherein the program includes program code for causing the computer to function as a communication apparatus comprising:
a search unit that searches for one or more connectable networks;
an exclusion unit that excludes information regarding a network through which communication is performed using a predetermined encryption scheme from information regarding the connectable networks;
a transmitter that transmits to an external apparatus the information regarding the connectable networks except for the information regarding the network excluded by the exclusion unit;
a receiver that receives information regarding a network selected by the external apparatus based on the transmitted information regarding networks, and a communication parameter for connecting to the selected network; and
a connection unit that connects to the selected network based on the information regarding the selected network received by the receiver and information regarding the communication parameter.

11. A non-transitory computer-readable storage medium, the storage medium storing a program that is executable by the computer, wherein the program includes program code for causing the computer to function as a communication apparatus comprising:
an acquisition unit that acquires information regarding one or more connectable networks for the external apparatus;
an exclusion unit that excludes information regarding a network through which communication is performed using a predetermined encryption scheme from information regarding the connectable networks for the external apparatus;
a display unit that displays a list of information regarding the connectable networks for the external apparatus, except for the information regarding the network excluded by the exclusion unit;
an operation unit that prompts a user to select a network from the displayed list of information regarding networks, and to prompt the user to enter a communication parameter used to connect to the selected network; and
a transmitter that transmits information regarding the selected network and the communication parameter to the external apparatus.
